(19) United States
(12) Patent Application Publication
(10) Pub. No.: US 2026/0065257 A1
(43) Pub. Date: Mar. 5, 2026

(54) Using Gestures and/or Sound-based Commands to Make Purchases on an Enabled Wearable Computing Device

(71) Applicant: Allan Hoving, Encinitas, CA (US)

(72) Inventor: Allan Hoving, Encinitas, CA (US)

(21) Appl. No.: 19/316,871

(22) Filed: Sep. 2, 2025

Related U.S. Application Data
(60) Provisional application No. 63/690,488, filed on Sep. 4, 2024.
(60) Provisional application No. 63/850,429, filed on Jul. 24, 2025.

(51) Int. Cl. G06Q 20/32; G06F 1/16; G06F 3/01; G06F 3/16; G06Q 30/0601; G06V 10/764

(52) U.S. Cl. CPC G06Q 20/321; G06F 1/163; G06F 3/017; G06F 3/167; G06Q 30/0627; G06V 10/764

(57) ABSTRACT

Gestures and/or sound-based commands are used to make purchases on a wearable computing device. The wearable computing device is configured to recognize detected gestures and/or sound-based commands as indicating to execute specific actions. The user sees an item of interest and points a camera/lens of the wearable computing device at the item. The user makes physical gestures and/or gives sound-based commands indicating to perform object recognition of the item. The wearable computing device detects the physical gesture(s) using sensors, and/or detects the sound-based command(s) utilizing a microphone. In response, an image of the item is created, and object recognition of the item is performed based on the image. Results of the object recognition are output. The user makes physical gestures and/or gives sound-based commands indicating to purchase the item. These are detected and recognized, and in response an instance of the item is purchased from an online source.

### CROSS-REFERENCE TO RELATED APPLICATION

The present application claims the benefit under 35 U.S.C. § 119(e) of U.S. Provisional Patent Application No. 63/850,429, entitled “Point and Gesture to Purchase Enabled Wearable Computing Device,” filed on Jul. 24, 2025, and having the same inventor and owner, the entire contents of which are incorporated herein by reference. The present application also claims the benefit under 35 U.S.C. § 119(e) of U.S. Provisional Patent Application No. 63/690,488, entitled “Wearable ecommerce device that enables user to point at objects and make quick purchase,” filed on Sep. 4, 2024, and having the same inventor and owner, the entire contents of which are incorporated herein by reference.

### TECHNICAL FIELD

This disclosure pertains generally to gesture controllable wearable computing devices, and more specifically to using gestures and/or sound-based commands to make purchases on an enabled wearable computing device.

### BACKGROUND

As people move around, both outside and in, they spontaneously see things around them that they would like to buy. For example, a person may see a specific shirt or other article of clothing of interest (for example, being worn by another person, in a display window, etc.). People also see ads with pictures of items they would like to buy, for example ads for given brands of toothpaste or soap with pictures of the products.

Many people carry smartphones. When a person sees an item of interest, s/he can take a smartphone out of their pocket or purse, attempt to locate the item for sale on one or more online retailer(s), and then purchase it through an online retailer. However, this involves a lot of steps, such as taking out the phone, trying to locate the desired item for sale, and operating the online retailer's app to place the order. In the best case scenario, this number of steps is inconvenient for a person trying to make a quick and easy purchase.

It is even less convenient for a person who is on a crowded sidewalk or the like, who would then block pedestrians or traffic while conducting the transaction. In social situations, it is often considered rude or awkward to take out a phone and conduct business instead of remaining engaged with the other people in the room. In many instances, the person might not even know what the item is or how to go about purchasing it, for example in the case of clothing, furniture, fixtures, or other types of items of a make and/or model unknown to the user.

It would be desirable to address these issues.

### SUMMARY

Gestures and/or sound-based commands are used to make purchases on a wearable computing device operated by a user. The wearable computing device is configured to recognize detected physical gestures and/or sound-based commands as indicating to execute specific actions. The user sees an item of interest and points the camera/lens of the wearable computing device at the item. This item can be in the form of a three dimensional physical object, or a graphical representation thereof (e.g., a photograph or the like of the item, for example in an advertisement).

The user makes one or more physical gestures and/or gives one or more sound-based commands indicating to perform object recognition of the item which is being pointed to by the lens and/or camera of the wearable computing device. The wearable computing device detects the physical gesture(s) using one or more sensors, and/or detects the sound-based command(s) utilizing a microphone. In response, the wearable computing device creates an image of the item, such as a photograph or video.

Object recognition of the item is performed based on the image. In some implementations, the wearable computing device transmits the image to a backend server computer which performs some or all of the object recognition, and returns results of the object recognition to the wearable computing device. The object recognition can involve using machine learning and/or artificial intelligence techniques to recognize the item based on graphical properties in the image and a dataset of identified object types and instances with given graphical properties.

The wearable computing device outputs results of the object recognition to the user. This can be in the form of a description of the item that has been recognized from the image. This output can be in the form of displaying results of the object recognition on a screen of the wearable computing device, or outputting speech or simulated speech describing results of the object recognition through at least one speaker of the wearable computing device. This later scenario can be used, for example, in instances in which the wearable computing device does not have a screen.

In some cases, the user may make at least one physical gesture and/or give one or more sound-based commands indicating to change at least one criterion concerning the object recognition. These gestures and/or sound-based commands are detected and recognized by the wearable computing device, which in response modifies information identifying the item (e.g., changes the size, color, make, model, etc.).

The user makes one or more physical gestures and/or gives one or more sound-based commands indicating to purchase the item. These gestures and/or sound-based commands are detected and recognized by the wearable computing device. In response to these gestures and/or sound-based commands, an instance of the item is purchased for the user from an online source. This purchasing can comprise the wearable computing device transmitting the directive to purchase the item to the backend server computer, which can perform some or all of the item purchasing functionality. In other implementations, the purchasing functionality is executed by the wearable computing device itself.

In either case, the instance of the item can be purchased from an online source according to profile information concerning the user. The profile information can include criteria such as login information for one or more online sources, payment method(s), shipping address(es), information concerning the user's clothing sizes, and other types of user preference and/or defaults. In one implementation, multiple online sources are searched for the item, which is then purchased from a specific one of the searched online sources based on factors such as best price, fastest shipping, user preference as indicated in the profile, etc. If the user does not have an account at the selected online source from which to purchase the item, an account on the selected online source can be automatically created for the user, using profile information.

Examples of wearable computing devices are smart glasses, smart watches, smart bracelets, smart necklaces, smart rings, smart clip-on devices, smart headphones, smart belt buckles, smart headbands, smart hats, etc. Some wearable computing devices do not have screens, in which case output can be via one or more speakers. Such speaker(s) can be embedded in the device itself, or in the form of physically separate communicatively coupled wearable speaker(s), such as Bluetooth connected earbuds.

By using the wearable computing device, the user can purchase items of interest without having to take out or otherwise use a phone, without manually opening an app, and without typing or otherwise manually inputting data.

The features and advantages described in this summary and in the following detailed description are not all-inclusive, and particularly, many additional features and advantages may be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resorting to the claims being necessary to determine such inventive subject matter.

### BRIEF DESCRIPTION OF THE DRAWINGS

FIG. 1 illustrates a network environment in which a gesture and purchase system can operate, according to some implementations.

FIG. 2 illustrates the operation of a gesture and purchase system, according to some implementations.

FIG. 3 illustrates a computer system suitable for implementing a gesture and purchase system, according to some implementations.

The Figures depict various implementations for purposes of illustration only. One skilled in the art will readily recognize from the following discussion that other implementations of the structures and methods illustrated herein may be employed without departing from the principles described herein.

### DETAILED DESCRIPTION

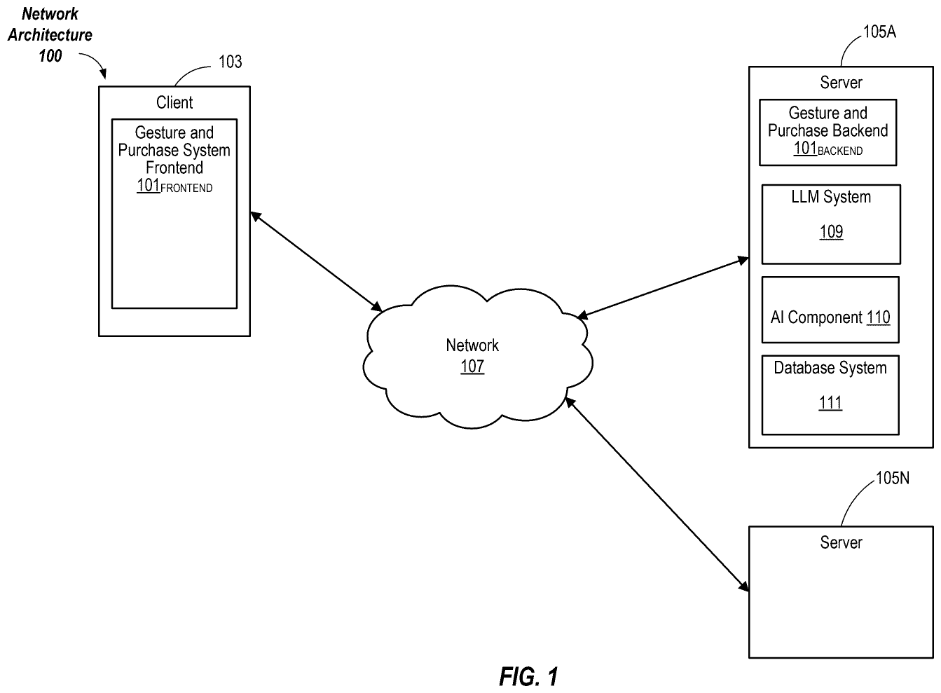

FIG. 1 is a high-level block diagram illustrating an exemplary network architecture in which a gesture and purchase system 101 can be implemented. The illustrated network architecture comprises two servers 105A-N (together may be referred to as “server 105”) as well as one client 103. In FIG. 1, a frontend component 101_{FRONTEND} of the gesture and purchase system 101 is illustrated as residing on the client 103, and a backend component 101_{BACKEND} of the gesture and purchase system 101, a large language module (LLM) 109, artificial intelligence (AI) module 110, and a database system 111 are illustrated as residing on server 105A. In one implementation, server 105A may be in the form of a backend server 105 made available by, e.g., a provider of the gesture and purchase system 101. It is to be understood that this is an example implementation only. In other implementations, the server(s) on which the backend component 101_{BACKEND} of the gesture and purchase system 101, the LLM 109, AI module 110, and/or the database system 111 reside can be provided by other entities, and may be in the form of cloud based resources provided by one or more third parties and/or the provider of the gesture and purchase system 101.

In various implementations, various functionalities of gesture and purchase system 101 can be instantiated on a client 103, or can be distributed among multiple servers 105 and/or clients 103 as desired. Additionally, although the LLM 109, AI module 110, and the database system 111 are each illustrated as residing on a single server (105A), it is to be understood that these systems may be distributed across multiple computing devices as desired.

The client 103 on which the frontend component 101 FRONTEND of the gesture and purchase system 101 resides is in the form of a wearable computing device operated by a user. Examples of wearable computing devices include smart watches and smart glasses, as well as smart jewelry (smart necklaces, bracelets, rings, etc.), smart clothing, smart clip-on devices (e.g., a small computing device that can easily be clipped to a shirt, tie or other article of clothing and appear to be jewelry or an ornamental accessory), smart belt buckles, etc. As used herein, “wearable computing device” means any computing device that can be worn or can be conveniently body borne (e.g., attached to clothing or the like as opposed to being carried or placed in a pocket or purse) that is capable of running software and connecting to a network (e.g., WiFi, 5G, 4G, etc.) and communicating with other computing devices. For example, a wearable computing device can communicate over the network to other computing devices in the cloud. As described below, wearable computing devices can be equipped with lenses, cameras, microphones, speakers, and/or various types of sensors.

Some wearable computing devices contain screens, such as smart glasses, smart watches, etc. Other wearable computing devices do not contain screens, such as some instances of smart necklaces, smart clip-on devices, etc. Wearable computing devices with screens can provide output to the user via the screen.

Wearable computing devices without screens typically provide output to the user via one or more speaker(s), in the form of audio output. Some wearable computing devices with screens can also provide audio output to the user via one or more speaker(s). In some implementations, the speaker(s) can be imbedded in the wearable device itself (e.g., a smart bracelet with an embedded speaker). In other implementations, the speaker(s) can be in the form of wearable earbuds or the like that are a separate physical apparatus from the rest of the wearable device, but communicate with the rest of the wearable device either wirelessly (e.g., via Bluetooth, Near Field Communication (NFC), or other wireless communication protocols) and/or via a connecting cable. For example, the user could wear a smart necklace, and an earbud coupled via Bluetooth.

In some implementations, the wearable speakers comprise the entirety of the wearable computing device, such as smart headphones with an embedded lens. Likewise, in some implementations, a wearable lens/camera is physically separate from the rest of the wearable computing device, such as a smart watch without a lens, communicatively coupled (e.g., either wirelessly or cabled as described above in the case of wearable speakers) to a wearable camera, for example embedded in a headband, clipped to a hat, etc. In other words, in some implementations, a wearable computing device comprises multiple wearable components that are communicatively coupled, with different functions being distributed between the different wearable components as desired.

The client 103 can communicate with the backend component 101_{BACKEND} of the gesture and purchase system 101, on which much of the more intensive computation described below may take place. The frontend component 101_{FRONTEND} of the gesture and purchase system 101 may be in the form of an application running on the wearable computing device and providing user-level functionality for utilizing and/or interacting with the gesture and purchase system 101, as well as various sensing and data capturing functionalities described below. Although only a single client 103 is illustrated, it is to be understood that the backend component 101_{BACKEND} of the gesture and purchase system 101 can support multiple clients in the form of multiple wearable computing devices, each running a copy of the frontend component 101 FRONTEND, and each being operated by a separate user.

The clients 103 and servers 105 are communicatively coupled to a network 107, for example via a network interface. Servers 105 can be in the form of, e.g., desktop and/or rack-mounted computing devices, located, e.g., in IT departments and/or data centers. Although FIG. 1 illustrates one client 103 and two servers 105 as an example, in practice many more (or fewer) clients 103 and/or servers 105 can be deployed. In one implementation, the network 107 is in the form of the internet. Other and/or additional networks 107 or network-based environments can be used in other implementations.

It is to be understood that the functionalities of the gesture and purchase system 101, the LLM system 109, the AI module 110, and the database system 111 can be distributed among multiple computer systems, including within a cloud-based computing environment in which some of the functionalities of the gesture and purchase system 101 are provided as a service over a network 107. It is to be understood that although the frontend and backend components of the gesture and purchase system 101, the LLM 109, the AI module 110, and the database system 111 are illustrated as discrete entities, the illustrated gesture and purchase system 101, LLM 109, AI module 110, and database system 111 represent collections of functionalities, which can be instantiated as a single or multiple modules on one or more computing devices as desired.

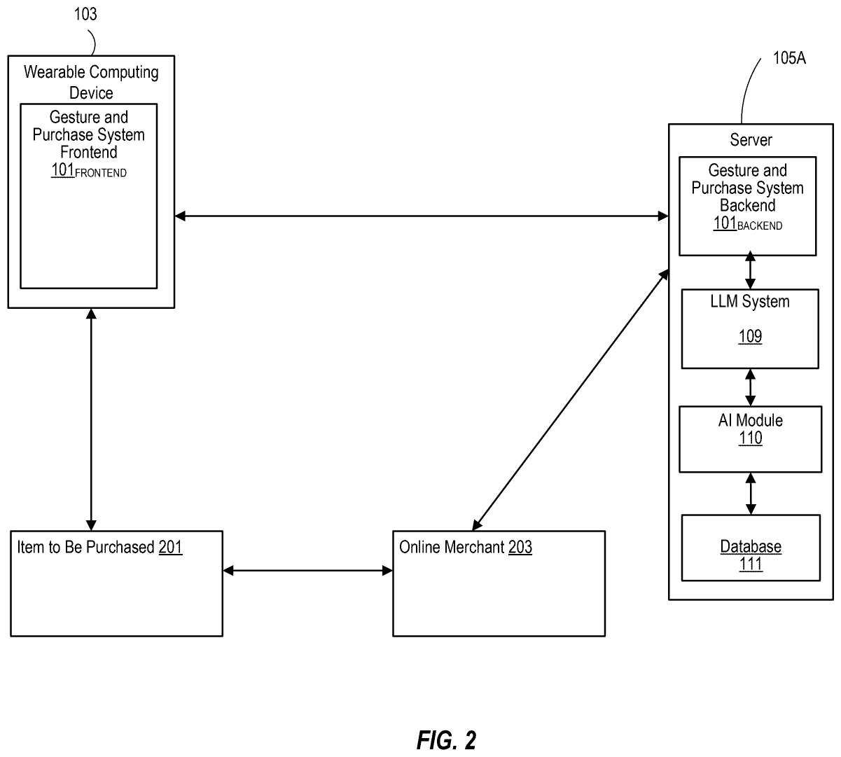

FIG. 2 illustrates an example implementation of the gesture and purchase system 101. A user with a wearable computing device on which the frontend component 101_{FRONTEND} of the gesture and purchase system 101 operates sees an item 201 of interest (for example, a specific sized container of a specific brand and type of shampoo, a given make and model of car, a specific brand and model of laptop computer, etc.). It is to be understood that the user may be looking at the item 201 itself, or a graphical representation of the item 201, for example a photograph or drawing in an advertisement. In one implementation, the user can aim a lens (e.g., of a camera) of the wearable device at the item 201. For example, the user may position the wearable computing device towards the item 201, for example by moving their head, arm, etc., depending upon on what part of their body the device is worn. In some instances, it may be more convenient for the user to move the item 201 into the range of camera lens of the device.

The gesture and purchase system 101 can then perform object recognition of the item 201, for example in response to the user making a given gesture or series of gestures and/or issuing a sound-based command indicating to recognize the item 201. In order to do so, the frontend component 101_{FRONTEND} of the gesture and purchase system 101 may first take a photograph or video of the item 201 in response to the detecting gesture(s) and/or sound-based command. The gesture and purchase system 101 can then perform the object recognition of the item 201 based on the image of the item 201 (e.g., photograph or video). Gesture and sound command detection and recognition are discussed in greater detail below.

Object recognition is the ability for software to identify and categorize objects in images or videos. Object recognition enables computers to simulate “seeing and understanding” objects in the world by identifying objects within visual data. Object recognition involves functionalities such as locating objects within an image (e.g., drawing bounding boxes around them, indicating their position and extent), and classifying objects as being of a specific type (e.g., human face, car, laptop computer, tube of toothpaste, etc.). Deep learning techniques such as convolutional neural networks may be used in object recognition, and enable computers to learn complex features and achieve impressive accuracy in recognizing not just classes of objects, but specific instances of objects (e.g., a given make and model of a product), for example based on a dataset of identified object types and instances with given graphical properties. Object recognition can also be implemented using non-neural approaches, in which typically features are defined using a methodology (e.g., the Viola-Jones object detection framework based on Haar features, scale-invariant feature transform (SIFT), histogram of oriented gradients (HOG) features, etc.), and then using a technique such as support vector machine (SVM) to do the classification. It is to be understood that the object recognition of items 201 can be performed at any desired level(s) of specificity (e.g., make and model, make model and further options such as size of container or color of object, etc.). Different artificial intelligence techniques can be employed in execution of object recognition in different implementations, for example using the LLM 109 and/or the AI module 110.

It is to be further understood that the image of the item 201 is captured by the wearable computing device and the frontend component 101_{FRONTEND} running thereon, whereas the more computationally intensive parts of the object recognition (e.g., the classification, neural techniques, etc.) can be performed by the server-side backend component 101_{BACKEND}, for example operating in conjunction with the LLM 109, AI module 110, and/or database 111. The frontend component 101_{FRONTEND} and backend component 101_{BACKEND} are in communication over the network. The specific distribution of the functionality between the frontend component 101_{FRONTEND}, backend component 101_{BACKEND}, and other components is a variable design parameter.

In some implementations, once the gesture and purchase system 101 on the wearable computing device has recognized an item 201, the frontend component 101_{FRONTEND} confirms the recognized item 201 with the user, for example either by displaying an image of the recognized item 201 on a screen, in some cases with a written description of the item 201 at any level of granularity (e.g., “recognize a 64 ounce plastic bottle of a given brand of dish soap,” “recognize a green cotton t-shirt size medium,” etc.). In some implementations, the frontend component 101_{FRONTEND} Of the gesture and purchase system 101 confirms the recognized item 201 to the user with an auditory description of the item 201 through the speaker at any level of granularity. In some implementations, the user can finetune or correct the recognition of the item 201, via gestures and/or sound-based commands (e.g., specific gestures to specify a larger or smaller size, cycle through different color or size options, etc., sound-based commands to edit the selection, etc.).

Once a specific item 201 has been recognized (and optionally confirmed or modified by the user), the user may elect to purchase the item 201. To do so, in one implementation the user makes a specific gesture, such as pointing directly at the item 201, finger snapping, nodding of the head, etc. In some implementations, a combination of gestures is utilized to indicate to purchase, such as the combination of pointing and then snapping one's fingers. The specific gesture or combination of gestures to make to indicate to purchase an item 201 is a variable design parameter, and in some implementations is user configurable. The gesture and purchase system 101 detects and recognizes the gesture.

Gesture recognition is the process of interpreting human movements, such as hand gestures (e.g., finger snapping, pointing, making a fist, etc.) or larger body movements (e.g., leaning to the left, touching the right knee, jumping). Gesture recognition involves detection of the gesture as computer input. Sensors in a computing device such as accelerometers, ambient light sensors, proximity sensors, gyroscopes, and others can generate data relevant to the detection and recognition of gestures. Cameras and the like can also do so. The data captured from the sensors/cameras can be analyzed to identify key features such as hand and finger positions, limb movements, etc. These features can then be classified (for example by the LLM 109 and/or artificial intelligence module 110) to identify the specific gesture. Once recognized, the gesture can trigger the gesture and purchase system 101 to execute a corresponding action or command. It is to be understood that the gesture and purchase system 101 can associate specific gestures and/or combinations of gestures with specific commands at any level of granularity. In some implementations, such associations are user configurable in whole or in part.

It is to be understood that gesture recognition can be performed via motion sensing (e.g., detecting that the user is pointing or finger snapping), visual sensing (e.g., a lens creating an image of the user pointing or finger snapping) or a combination of these. It is to be further understood that the various functionalities of gesture recognition can be distributed between the frontend component 101_{FRONTEND} and the backend component 101_{BACKEND}, LLM 109, AI module 110, and/or database 111 as desired, with more computationally intensive processing often being performed server-side.

In some implementations, rather than (or in addition to) making a physical gesture to indicate to purchase an item 201, the user can make a sound-based command which is recognized by the gesture and purchase system 101. Such a command could be, for example, saying “buy it” or “purchase now,” whistling according to a given pattern, making a specific series of clicking noises, etc. Sound-based command recognition allows computing devices to recognize and respond to spoken words and other sound-based input. Voice recognition converts human speech into digital data, enabling users to interact with devices by speaking. Voice recognition systems analyze audio input (e.g., using the LLM 109 and/or artificial intelligence module 110) to identify spoken words. Not all sound recognition systems are limited to voice recognition. Some such systems can also convert non-speech based sound into digital data, and recognize specific sound patterns which can in turn be associated with specific commands (e.g., specific patterns or repetitions of whistling, clicking, etc.). The gesture and purchase system 101 can thus identify specific sound-based commands or instructions, and execute corresponding actions in response. It is to be understood that the gesture and purchase system 101 can associate specific sounds (e.g., given words or combinations of words, etc.) with specific commands at any level of granularity. In some implementations, such associations are user configurable in whole or in part.

In some implementations, the audio recognition functionality of the gesture and purchase system 101 also includes individual speaker recognition, which identifies the individual speaker's voice to provide personalized responses or security features. It is to be understood that as with other functionalities described above, the various functionalities of sound recognition including voice recognition can be distributed between the frontend component 101_{FRONTEND} and the backend component 101_{BACKEND}, LLM 109, AI module 110, and/or database 111 as desired, with more computationally intensive processing often being performed server-side.

Once the user has indicated to purchase a given item 201, the gesture and purchase system 101 purchases that item 201 for the user. The purchasing is performed online, by the backend component 101_{BACKEND} (or in some implementations the frontend component 101_{FRONTEND}) communicating electronically with an online merchant 203 or other online source for the item 201. In different implementations, the backend component 101_{BACKEND} Can utilize various sources for obtaining the item 201, depending upon the nature of the item 201 and the user's preferences. Typically, the gesture and purchase system 101 maintains a profile for a given user, containing information previously provided by the user such as payment methods such as stored credit card or banking information, shipping addresses, etc. The profile can contain information at any level of granularity (e.g., the user's specific clothing sizes, preferred colors, brands, of sources goods, shipping methods/speeds, etc.). The user can create and edit their profile, for example by operating the wearable computing device, or by operating a separate application on a more conventional computing system. The backend component 101_{BACKEND} can use information in the user's profile to automatically purchase the item 201 for the user, to whom it will be delivered in due course.

In different implementations, the gesture and purchase system 101 can interact with one or multiple online merchants 203 to purchase an item 201. In some cases, the gesture and purchase system 101 uses existing accounts of the user on such online merchants 203 (for example using login information and other parameters stored in the user's profile). In scenarios in which the user does not have an account on a given online merchant 203, the gesture and purchase system 101 can create an account for the user using profile information, or interact with the online merchant 203 as a guest in a case in which login is not required. The gesture and purchase system 101 can search multiple online merchants 203 for the item 201, and purchase from a specific one based on a variety of user configurable and/or default factors, such as best price, fastest delivery time, most reward points available, etc. In some instances, a given user profile may indicate to select certain online merchants 201 over others regardless of price, or unless the savings exceeds a given threshold, or other factors of this nature.

Using the gesture and purchase system 101 on the wearable computing device, a user can automatically purchase an item 201 of interest that the user sees while out and about with a simple gesture or sound-based command, and without having to take out a or otherwise use a (smart)phone, manually open an app, type in or otherwise manually enter information, etc. In some implementations, the user can do so without interacting with a screen at all.

In some implementations, in addition to the gesture and/or sound-based command to purchase an item 201, the gesture and purchase system is further configured to recognize and respond to other gestures and/or sound-based commands, for example to provide more options concerning an item 201 to be purchased (e.g., output and/or select different sizes, colors, and/or other properties, change defaults, designate the item 201 as a gift), etc.

It is to be understood that functionality described herein can be instantiated (for example as object code or executable images) within the system memory (e.g., RAM, ROM, flash memory) of any computer system, such that when the processor of the computer system processes a module thereof, the computer system executes the associated functionality. As used herein, the terms “computer system,” “computer,” “client,” “client computer,” “server,” “server computer” and “computing device” mean one or more computers configured and/or programmed to execute the described functionality. Additionally, program code to implement functionalities described herein can be stored on computer-readable storage media. Any form of tangible computer readable storage medium can be used in this context, such as magnetic, solid state, and/or optical storage media. As used herein, the term “computer-readable storage medium” does not mean an electrical signal separate from an underlying physical medium.

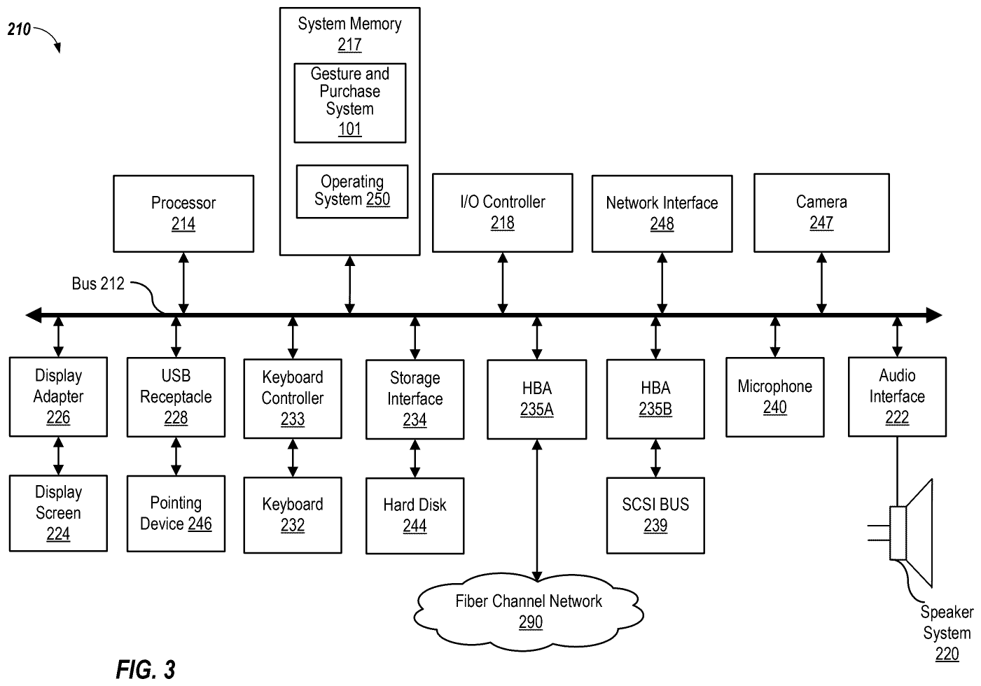

FIG. 3 is a block diagram of an example computer system 210 suitable for implementing the frontend and/or backend of a gesture and purchase system 101. Note that the frontend is implemented on a wearable computing device, whereas the backend is typically implemented on a desktop or rack-mounted computing device, such that the specific components included as part of the respective computer systems will vary accordingly.

As illustrated, one component of the computer system 210 is a bus 212. The bus 212 communicatively couples other components of the computer system 210, such as at least one processor 214, system memory 217 (e.g., random access memory (RAM), read-only memory (ROM), flash memory), an input/output (I/O) controller 218, an audio output interface 222 communicatively coupled to an audio output device such as a speaker 220, a microphone 240, a display adapter 226 communicatively coupled to a video output device such as a display screen 224, one or more interfaces such as Universal Serial Bus (USB) receptacles 228 or the like, a keyboard controller 233 communicatively coupled to a keyboard 232, a storage interface 234 communicatively coupled to one or more (solid state and/or magnetic) hard disk(s) 244 (or other form(s) of storage media), a host bus adapter (HBA) interface card 235A configured to connect with a Fiber Channel (FC) network 290, an HBA interface card 235B configured to connect to a SCSI bus 239, a pointing device 246 (e.g., a mouse) coupled to the bus 212, e.g., via a USB receptacle 228 as illustrated, or directly, a camera 247 coupled to the bus 212, and one or more wired and/or wireless network interface(s) 248 coupled, e.g., directly to the bus 212.

Other components (not illustrated) may be connected in a similar manner (e.g., various types of sensors, scanners, printers, etc.). Conversely, all of the components illustrated in FIG. 3 need not be present (e.g., wearable computing devices do not have external physical keyboards 232, and may lack pointing devices 246 and/or screens 224. The various components can be interconnected in different ways from that shown in FIG. 3.

The bus 212 allows data communication between the processor 214 and system memory 217, which, as noted above may include ROM and/or flash memory as well as RAM. The RAM is typically the main memory into which the operating system 250 and application programs are loaded. The ROM and/or flash memory can contain, among other code, the Basic Input-Output system (BIOS) which controls certain basic hardware operations. Application programs can be stored on a local computer readable medium (e.g., hard disk 244, solid state media) and loaded into system memory 217 and executed by the processor 214. Application programs can also be loaded into system memory 217 from a remote location (i.e., a remotely located computer system 210), for example via the network interface 248. In FIG. 3, the gesture and purchase system 101 is illustrated as residing in system memory 217.

The storage interface 234 is coupled to one or more hard disks 244 (and/or other standard storage media). The hard disk(s) 244 may be a part of computer system 210 or may be physically separate and accessed through other interface systems.

The network interface 248 can be directly or indirectly communicatively coupled to a network 115 such as the internet. Such coupling can be wired or wireless.

As will be understood by those familiar with the art, the subject matter described herein may be embodied in other specific forms without departing from the spirit or essential characteristics thereof. Likewise, the particular naming and division of the portions, modules, agents, managers, components, functions, procedures, actions, layers, features, attributes, methodologies, data structures, user interface components, and other aspects are not mandatory or significant, and the mechanisms that implement the functionality and its features may have different names, divisions, and/or formats. The foregoing description, for purpose of explanation, has been described with reference to specific implementations. However, the illustrative discussions above are not intended to be exhaustive or limited to the precise forms disclosed. Many modifications and variations are possible in view of the above teachings. The implementations were chosen and described to best explain relevant principles and their practical applications, to thereby enable others skilled in the art to best utilize various implementations with or without various modifications as may be suited to the particular use contemplated.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic device, that manipulates and transforms data represented as physical (electronic) quantities within the computer system's registers and memories into other data similarly represented as physical quantities within the computer system memories or registers or other such information storage, transmission or display devices.

The structure, algorithms, and/or interfaces presented herein are not inherently tied to any particular computer or other apparatus. Various general-purpose systems may be used with programs in accordance with the teachings herein, or it may prove convenient to construct more specialized apparatus to perform the method blocks. The structure for a variety of these systems will appear from the description above. In addition, the specification is not described with reference to any particular programming language. It will be appreciated that a variety of programming languages may be used to implement the teachings of the specification as described herein.

It is also to be understood that figures herein depict various implementations for purposes of illustration only. One skilled in the art will readily recognize from the following discussion that other implementations of the structures and methods illustrated herein may be employed without departing from the principles described herein.

Accordingly, the disclosure is intended to be illustrative, but not limiting.

What is claimed:

1. A method for using gestures and/or sound-based commands to make purchases on a wearable computing device operated by a user, the method comprising:
detecting, by the wearable computing device, at least one physical gesture and/or sound-based command indicating to perform object recognition of an item which is being pointed to by a lens and/or camera of the wearable computing device;
in response to the at least one physical gesture and/or sound-based command indicating to perform object recognition of the item, creating an image of the item, by the wearable computing device, and performing object recognition of the item based on the image;
outputting results of the object recognition, by the wearable computing device;
detecting, by the wearable computing device, at least one physical gesture and/or sound-based command indicating to purchase the item; and
in response to the at least one gesture and/or sound-based command indicating to purchase the item, purchasing an instance of the item from an online source.

2. The method of claim 1 further comprising:
recognizing detected physical gestures and/or sound-based commands as indicating to execute specific actions.

3. The method of claim 1 wherein detecting, by the wearable computing device, at least one physical gesture and/or sound-based command indicating to perform object recognition of an item further comprises:
utilizing at least one sensor, by the wearable computing device, to detect the user making at least one physical gesture; and
recognizing the at least one physical gesture as indicating to perform object recognition of the item.

4. The method of claim 1 wherein detecting, by the wearable computing device, at least one physical gesture and/or sound-based command indicating to purchase the item further comprises:
utilizing at least one sensor, by the wearable computing device, to detect the user making at least one physical gesture; and
recognizing the at least one physical gesture as indicating to purchase the item.

5. The method of claim 1 wherein detecting, by the wearable computing device, at least one physical gesture and/or sound-based command indicating to perform object recognition of an item further comprises:
utilizing a microphone, by the wearable computing device, to detect the user making at least one sound; and
recognizing the at least one sound as indicating to perform object recognition of the item.

6. The method of claim 1 wherein detecting, by the wearable computing device, at least one physical gesture and/or sound-based command indicating to purchase the item further comprises:
utilizing a microphone, by the wearable computing device, to detect the user making at least one sound; and
recognizing the at least one sound as indicating to purchase the item.

7. The method of claim 1 wherein the item which is being pointed to by a lens and/or camera of the wearable computing device further comprises:
a three dimensional physical object.

8. The method of claim 1 wherein the item which is being pointed to by a lens and/or camera of the wearable computing device further comprises:
a graphical representation of a three dimensional physical object.

9. The method of claim 1 wherein performing object recognition of the item based on the image further comprises:
using machine learning to recognize the item based on graphical properties in the image and a dataset of identified object types and instances with given graphical properties.

10. The method of claim 1 wherein performing object recognition of the item based on the image further comprises:
using artificial intelligence to recognize the item based on graphical properties in the image and a dataset of identified object types and instances with given graphical properties.

11. The method of claim 1 wherein performing object recognition of the item based on the image further comprises:
transmitting the image, by the wearable computing device to a backend server computer; and
receiving results of the object recognition, by the wearable computing device from the backend server computer, the backend server computer having performed object recognition of the image.

12. The method of claim 1 wherein outputting results of the object recognition further comprises:
displaying results of the object recognition on a screen of the wearable computing device.

13. The method of claim 1 wherein outputting results of the object recognition further comprises:
outputting speech or simulated speech describing results of the object recognition through at least one speaker of the wearable computing device.

14. The method of claim 1 wherein outputting results of the object recognition further comprises:
detecting, by the wearable computing device, at least one physical gesture and/or sound-based command indicating to change at least one criterion concerning the object recognition; and
in response to the at least one physical gesture and/or sound-based command indicating to change at least one criterion concerning the object recognition, modifying information identifying the item.

15. The method of claim 1 wherein purchasing an instance of the item from an online source further comprises:
purchasing the instance of the item from an online source according to profile information concerning the user of the wearable computing device.

16. The method of claim 15 wherein the profile information concerning the user of the wearable computing device further comprises at least two criteria from a group of criteria including:
login information for at least one online source, at least one payment method, at least one shipping address, information concerning clothing size, and user preference information.

17. The method of claim 1 wherein purchasing an instance of the item from an online source further comprises:
searching multiple online sources for the item; and
purchasing the instance of the item from a specific one of the searched online sources.

18. The method of claim 1 wherein purchasing an instance of the item from an online source further comprises:
selecting a specific online source from which to purchase the item; and
responsive to the user not having an account on the selected online source, using profile information to create an account for the user on the selected online source; and
purchasing the instance of the item from the selected online source.

19. The method of claim 1 wherein the wearable computing device is one of:
smart glasses, a smart watch, a smart bracelet, a smart necklace, a smart ring, a smart clip-on device, smart headphones, a smart belt buckle, a smart headband, and a smart hat.

20. The method of claim 1 wherein the wearable computing device further comprises:
a wearable computing device does not have a screen.

21. The method of claim 20 wherein the wearable computing device further comprises:
a wearable computing device that does not have a screen communicatively coupled to at least one physically separate speaker.

22. The method of claim 1 further comprising:
performing all of the steps of the method without the user using a phone, manually opening an app, typing, or manually inputting data.

23. A method for using gestures and/or sound-based commands to make purchases for a user operating a wearable computing device, the method comprising:
receiving, by a server computer from the wearable computing device, an image of an item captured by a lens and/or camera of the wearable computing device, and an indication of detection by the wearable computing device of at least one physical gesture and/or sound-based command indicating to perform object recognition of the item;
in response to receipt of the indication of detection by the wearable computing device of the at least one physical gesture and/or sound-based command indicating to perform object recognition of the item, performing object recognition of the item based on the image, by the server computer;
transmitting, by the server computer to the wearable computing device, results of the object recognition;
receiving, by the server computer from the wearable computing device, an indication of detection by the wearable computing device of at least one physical gesture and/or sound-based command indicating to purchase the item; and
in response to receipt of the indication of detection by the wearable computing device of the at least one physical gesture and/or sound-based command indicating to purchase the item, purchasing an instance of the item by the server computer, from an online source.

24. The method of claim 23 wherein performing object recognition of the item based on the image further comprises:
using machine learning to recognize the item based on graphical properties in the image and a dataset of identified object types and instances with given graphical properties.

25. The method of claim 23 wherein performing object recognition of the item based on the image further comprises:
using artificial intelligence to recognize the item based on graphical properties in the image and a dataset of identified object types and instances with given graphical properties.

26. The method of claim 23 wherein purchasing an instance of the item from an online source further comprises:
purchasing the instance of the item from an online source according to profile information concerning the user of the wearable computing device.

27. The method of claim 26 wherein the profile information concerning the user of the wearable computing device further comprises at least two criteria from a group of criteria including:
login information for at least one online source, at least one payment method, at least one shipping address, information concerning clothing size, and user preference information.

28. The method of claim 23 wherein purchasing an instance of the item from an online source further comprises:
searching multiple online sources for the item; and
purchasing the instance of the item from a specific one of the searched online sources.

29. The method of claim 23 wherein purchasing an instance of the item from an online source further comprises:
selecting a specific online source from which to purchase the item; and
responsive to the user not having an account on the selected online source, using profile information to create an account for the user on the selected online source; and
purchasing the instance of the item from the selected online source.

30. The method of claim 23 wherein the physical gestures and/or sound-based commands further comprise:
physical gestures made by the user detected by the wearable computing device utilizing at least one sensor.

31. The method of claim 23 wherein the physical gestures and/or sound-based commands further comprise:
sounds made by the user detected by the wearable computing device utilizing a microphone.

32. A wearable computing device comprising:
at least one processor;
computer memory;
a camera and/or lens;
at least one sensor capable of detecting physical gestures; and
program code configured that, when loaded into the computer memory and executed by the at least one processor, causes the wearable computing device to perform the following steps:
detecting at least one physical gesture and/or sound-based command indicating to perform object recognition of an item which is being pointed to by the lens and/or camera;
in response to the at least one physical gesture and/or sound-based command indicating to perform object recognition of the item, creating an image of the item, and performing object recognition of the item based on the image;
outputting results of the object recognition;
detecting at least one physical gesture and/or sound-based command indicating to purchase the item; and
in response to the at least one gesture and/or sound-based command indicating to purchase the item, purchasing an instance of the item from an online source.

33. The wearable computing device of claim 32 wherein performing object recognition of the item based on the image further comprises:
transmitting the image, by the wearable computing device to a backend server computer; and
receiving results of the object recognition, by the wearable computing device from the backend server computer, the backend server computer having performed object recognition of the image.
